(19) United States
(12) Patent Application Publication
(10) Pub. No.: US 2017/0017655 A1
(43) Pub. Date: Jan. 19, 2017

(54) CANDIDATE SERVICES FOR AN APPLICATION

(71) Applicant: HEWLETT PACKARD ENTERPRISE DEVELOPMENT LP, Houston, TX (US)

(72) Inventors: Jervis Pinto, Fort Collins, CO (US); Mehmet Kivanc Ozonat, San Jose, CA (US); William K. ., San Mateo, CA (US); Mehmet Oguz Oguz, Sunnyvale, CA (US); Alkiviadis Simitsis, Santa Clara, CA (US)

(73) Assignee: Hewlett Packard Enterprise Development LP, Houston, TX (US)

(21) Appl. No.: 15/114,134

(22) PCT Filed: Mar. 31, 2014
(86) PCT No.: PCT/US2014/032396

§ 371 Date: Jul. 26, 2016

(51) Int. Cl. G06F 17/30; G06N 5/04; G06N 99/00

(52) U.S. Cl. CPC G06F 17/3053; G06F 17/30864; G06F 17/30554; G06N 99/005; G06N 5/04

(57) ABSTRACT

Methods, apparatus, systems and articles of manufacture are disclosed to provide candidate services for an application. An example method includes determining a plurality of candidate services for a cloud application, determining an indication that a first candidate service from the plurality of candidate services is more relevant to the cloud application than a second candidate service based on a first prediction score corresponding to the first candidate service and a second prediction score corresponding to the second candidate service; presenting the first candidate service and the second candidate service to a user based on the first prediction score and the second prediction score; and adjusting a first weight corresponding to the first candidate service and a second weight corresponding to the second candidate service based on whether the first candidate service or the second candidate service is selected for inclusion in the cloud application.

### BACKGROUND

In software development, application service platforms (e.g., a cloud application services platform (CLASP), etc.) include and/or provide access to an increasing number of application services. Each application service may be an independent program with inputs and outputs that may be executed in a cloud environment or other similar environments.

In some examples, a user (e.g., a software developer) may group and/or combine multiple services (e.g., in series or in parallel) to compose a new service by executing the grouped and/or combined services. The composed new service may then be added to the catalog of services for the application services platform and further used in the composition of other services.

A user interface (e.g., a visual programming graphical user interface) for composing new services may provide the user with full access to the catalog and facilitate the composition of the new service. Accordingly, a user may select services for inclusion in a new service composition via a user interface.

### BRIEF DESCRIPTION OF THE DRAWINGS

FIG. 1 illustrates an example application services platform including an example service assistant for providing adaptive user assistance in the application services platform.

FIG. 2 illustrates an example graphical user interface for composing an application service.

FIG. 3 is a block diagram of the example service assistant of FIG. 1 constructed in accordance with the teachings of this disclosure.

FIG. 4 is a flowchart representative of example machine readable instructions that may be executed to implement the service assistant of FIGS. 1 and/or 3.

FIG. 5 is a flowchart representative of a portion of the example machine readable instructions of FIG. 4 that may be executed to implement the service assistant of FIGS. 1 and/or 3 to calculate a candidate service score.

FIG. 6 is a flowchart representative of a portion of the example machine readable instructions of FIG. 4 that may be executed to implement the service assistant of FIGS. 1 and/or 3 to adjust rankings of candidate services.

FIG. 7 is a flowchart representative of a portion of the example machine readable instructions of FIG. 4 that may be executed to implement the service assistant of FIGS. 1 and/or 3 to adjust weight calculations.

FIG. 8 is a block diagram of a processor platform capable of executing the instructions of FIG. 4 to implement the service assistant of FIGS. 1 and/or 3.

### DETAILED DESCRIPTION

Application services platforms may include thousands of application services. New application services may be developed and include a plurality of the available application services supported by the application services platform. Accordingly, when developing a new application service, an application developer may need to scan and/or search through the many thousands of applications of the application services platform to include a particular application service in a new application service under development. Thus, example methods, apparatus, and articles of manufacture are described herein to provide adaptive user assistance in an application services platform to efficiently identify and/or select application services to be included in an application service composition.

Examples disclosed herein predict and/or suggest an application service(s) to be included in an application composition based on at least one characteristic of the application services platform using an adaptive prediction score calculation. As used herein, an application composition is an application service that is being built, developed, edited, created, etc. by a user (e.g., using application development software and/or a user interface). As used herein, example characteristics may include available application services (e.g., applications from an application services catalog), a current composition of an application service, a source application service of an application services platform, a query from a user, etc.

In examples disclosed herein, an application service assistant learns to predict which service(s) a user may wish to include in an application composition. For example, a learning model described herein may identify a user's preferences by observing the user's behavior (e.g., how the user composes and/or edits application services) and/or interaction within the application services platform. Accordingly, predictions fora first user may be different than predictions for a second user despite the same application services being available to both users. In some examples, this learning element of the adaptive user assistance described herein takes place in the background while the application services platform is building, compiling, executing, and/or managing application services.

An example method involves determining a plurality of candidate services for a cloud application and determining that a first candidate service from the plurality of candidate services is more relevant to the cloud application than a second candidate service based on a first prediction score corresponding to the first candidate service and a second prediction score corresponding to the second candidate service. The example method further involves presenting the first candidate service and the second candidate service to a user based on the first prediction score and the second prediction score, and adjusting a first weight corresponding to the first candidate service and a second weight corresponding to the second candidate service based on whether the first candidate service or the second candidate service is selected for inclusion in the cloud application.

An example apparatus described herein includes a composition analyzer that analyzes an application composition and determines that a candidate service is to be selected for inclusion in the application composition. An example service predictor of the apparatus learns a relevance of a candidate service to particular application compositions based on previous uses of the application services within other application services. For example, the service predictor predicts a most relevant candidate service to be included in the application composition. The service predictor may predict the most relevant candidate service based on at least one of a calculation of prediction scores for each of a plurality of candidate services, a comparison of the prediction scores, and/or a prediction of a most relevant candidate service based on the compared prediction scores.

Examples disclosed herein involve a service selection interface to present an identified most relevant candidate service and/Ora plurality of candidate services. An example weight manager described herein manages weights corresponding to characteristics of an application composition and/or application services platform associated with the application composition. For example, the weight manager may adjust weights used in the calculation of prediction scores based on a selected service from a most relevant candidate service and a plurality of other candidate services. In some examples, the weight manager adjusts weights of a weight vector used to calculate prediction scores for each of a plurality of candidate services. In some such examples, the weights include local weights based on a user's behavior and/or session history and global weights based on all users of an application service platform or other application service platforms.

Examples disclosed herein involve identifying a source service of an application composition and determining that a destination service for the application composition is to be associated with a source service. Examples disclosed herein further involve predicting whether a destination service is to include at least one of a first candidate service or a second candidate service, and presenting the first candidate service and the second candidate service via a display to a user for selection as the destination service of the application composition.

Accordingly, examples disclosed herein allow for adaptive user assistance in composing application services based on characteristics of an application composition and an application services platform. Examples disclosed herein learn a user's preferences based on selections of candidate services provided using adaptive user assistance implementations described herein (e.g., acceptance or rejection of suggested/predicted candidate services).

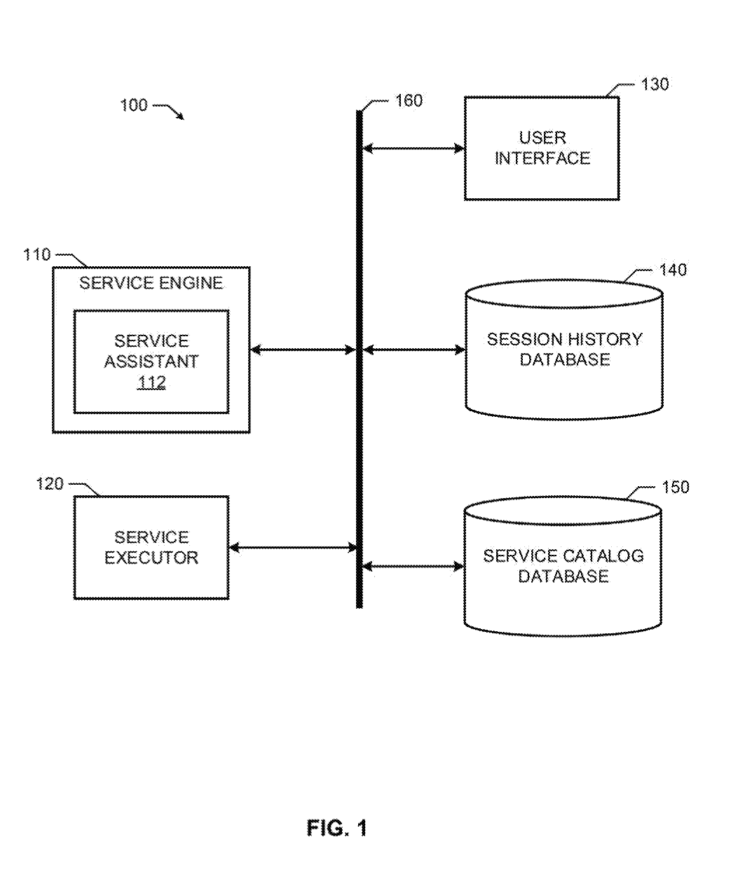

FIG. 1 illustrates an example application services platform 100 (e.g., a cloud application services platform) in which adaptive user assistance may be implemented to compose application services. The application services platform 100 of the illustrated example of FIG. 1 includes a service engine 110 including an example service assistant 112 constructed in accordance with the teachings of this disclosure. The service engine 110 of the illustrated example of FIG. 1 is in communication with a service executor 120, a user interface 130, a session history database 140, and a service catalog 150 via a communication bus 160.

The user interface 130 of FIG. 1 may be implemented by input device(s) (e.g., a keyboard, mouse, touchscreen, etc.) and/or output device(s) (e.g., a display, monitor, touchscreen, etc.). The session history database 140 of FIG. 1 stores application services history corresponding to behaviors and/or selections of a user of the application services platform 100. For example, the session history database 140 may store events such as service execution(s), application composition(s) composed in the application service platform 100, application service relationship(s) within composed application service(s) (e.g., whether application services are used together and how they are used together in application compositions), etc. The service catalog database 150 stores a catalog of available application services that may be included in application compositions and/or executed via the application services platform 100. For example, the services catalog 150 stores application services generated by the example service engine 110, and/or application services generated by other service engines in communication with the application services platform 100. Accordingly, the services catalog 150 may receive application services (e.g., via updates) from other application service platforms in communication with (e.g., via a network, such as the Internet, local area network (LAN), etc.) the application services platform 100.

The example service executor 120 of FIG. 1 executes application services on data associated with the application services platform 100. For example, a user may instruct the service executor 120 via the user interface 130 to execute a service from the service catalog 150. The example application service may be executed to analyze/process data and/or provide corresponding results of the analysis to the user. Such example application services may include analytics, data mining, data processing, image/video data analysis (e.g., image detection, image processing, etc.), audio data analysis, data clustering, statistical analysis, data classifications, etc.

The service engine 110 of FIG. 1 generates application services to be included and/or executed in the application services platform 100. The service engine 110 of the illustrated example composes new application services using instructions from the user interface 130 and/or using other application services in the service catalog database 140. The service engine 110 compiles information from the user interface 130 and the service catalog database 150 to generate new application services. The service engine 110 stores newly generated application services in the service catalog database 150. In some examples, these newly generated application services may be provided to other application service platforms in communication with the application services platform 100 (e.g., via a network or other communication link).

The service engine 110 of the example of FIG. 1 includes a service assistant 112 constructed in accordance with the teachings of this disclosure. The service assistant 112 monitors application compositions being built by the service engine 110 and/or user interface 130. As described herein, the service assistant 112 provides adaptive user assistance in composing application services by analyzing the application composition, available application services in the service catalog database 150, information in the session history database 140, and/or information from the user interface 130 (e.g., queries, user preference inputs, etc.).

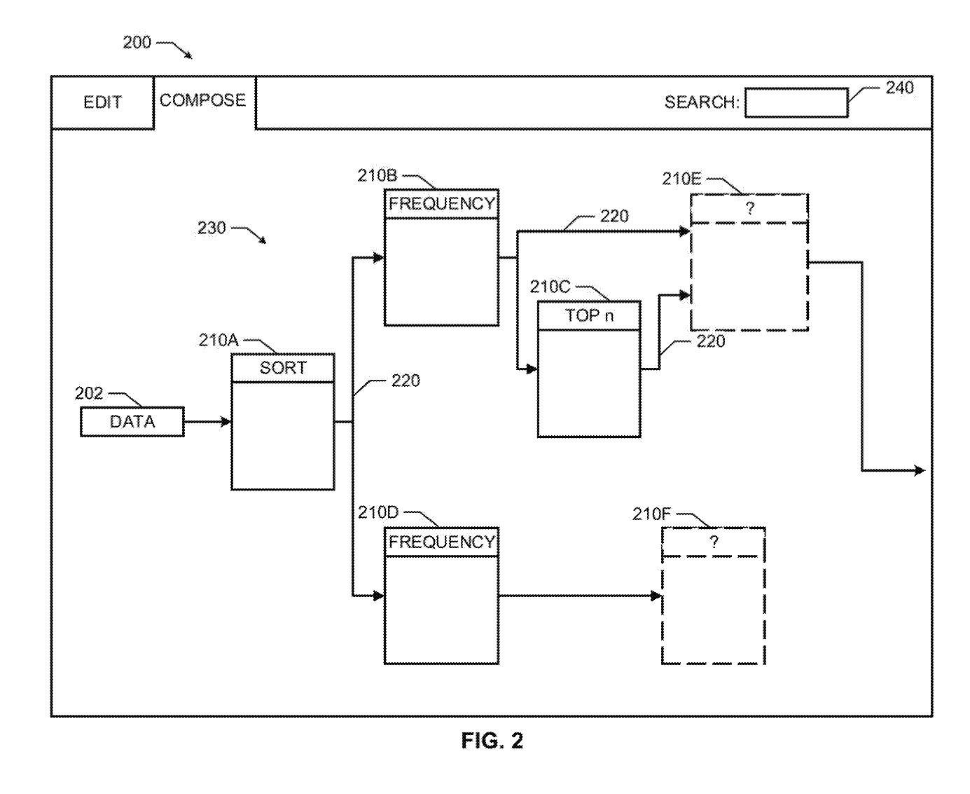

FIG. 2 illustrates an example graphical user interface 200 for composing an application service. The graphical user interface 200 may be implemented via the user interface 130 of FIG. 1. The graphical user interface 200 illustrates application service icons 210A-210D representative of corresponding application services that are to be executed to analyze and/or process the data 202. The application service icons 210A-210D are connected via respective connectors 220. For ease of readability, application services are referred herein using the same numerical labels as corresponding application service icons 210A-210F.

The application services 210A-210D of the example in FIG. 2 in combination with the connectors 220 are considered an application composition 230 as described herein. The connectors 230 indicate a flow of execution of the application services 210A-210D should the application composition be compiled (e.g., by the service engine 110) and executed (e.g., by the service executor 120). In generating the application composition of FIG. 2, a user may associate, via the user interface 130, a first application service (e.g., 210A) with a second application service (e.g., 2108) via a connector 220. For example, when the application composition 230 is completed, compiled, and executed, the first application service 210A is executed prior to execution of the second application service 210B. As used herein, the first application service 210A may be referred to as a source application, and the second application service 210B may be referred to as a destination service in terms of the relationship of the first application service 210A and the second application service 210B.

In the illustrated example of FIG. 2, a user may seek to include additional application services, represented by dashed application service icons 210E, 210F in the composition 230. A user may use the graphical user interface 200 to identify candidate services (e.g., application services in the service catalog 150) to be included in application. In some examples, a user includes a search query to identify candidate services using an example search box 240. As used herein, a candidate service selected for additional application services (e.g., one of the additional application services 210E, 210F) may be referred to as a destination service.

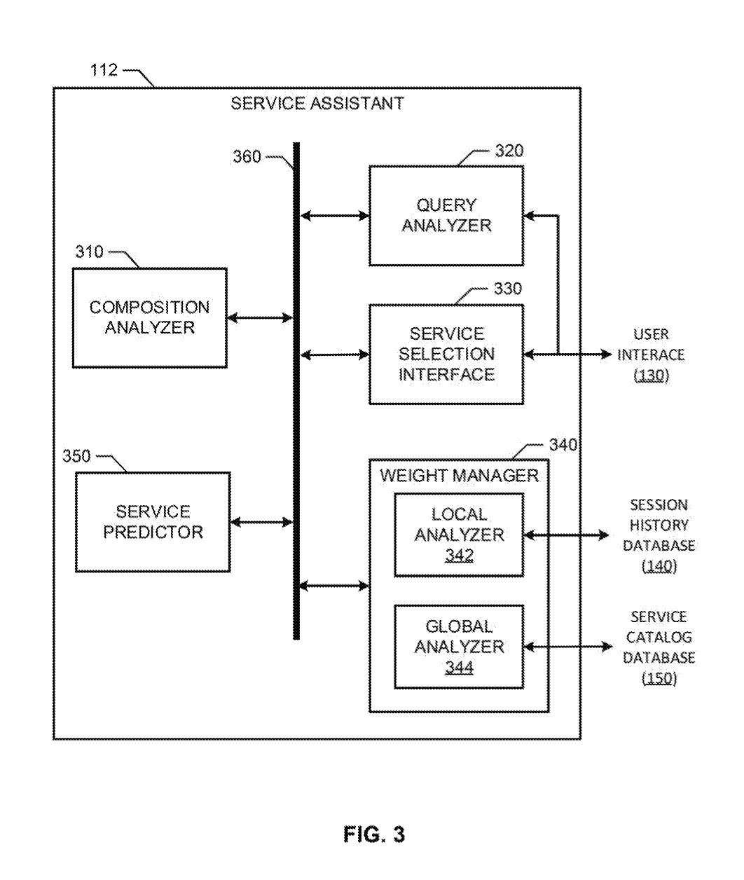

The graphical user interface 200 of the illustrated example of FIG. 2 is a visual programming model, though other types of programming models may be used to compose new application services. As described herein, application compositions (e.g., the composition 230) are comprised of application services, which may be comprised of other application services. As used herein, each application service receives data (e.g., input(s)), processes or analyzes the data, and provides results (e.g., output(s)). In the illustrated example of FIG. 2, the service assistant 112 of FIG. 1 and/or FIG. 3 monitors the composition 230 and identifies candidate services from the service catalog database 150 that may be included in the composition 230 (e.g., when a user indicates that a new service is to be added to the composition 230). For example, when a user indicates that the additional services represented by application service icons 210E, 210F are to be included, the service assistant 112 of FIG. 1 may suggest candidate services to be included in the application composition 230. A user may indicate that an additional application service is to be added to the application composition 230 of FIG. 2 by clicking on an associated application service icon 210B and/or 210C for additional application service icon 210E. In some examples a user may indicate that an additional application service is to be added by clicking on application service icon 210D for additional application service icon 210F, or using other suitable user interface menus or functions. Upon such an indication, the service assistant 112 provides predicted or suggested candidate services (e.g., corresponding to the additional application service icons 210E, 210F) as described herein via a dialog box, pop-up, prompt, or other suitable technique.

FIG. 3 is a block diagram of an service assistant 112. The example service assistant 112 of FIG. 3 may be used to implement the service assistant 112 of FIG. 1. The example service assistant 112 of FIG. 3 predicts and/or provides suggested candidate services for inclusion in application compositions (e.g., the application composition 230). The example service assistant 112 of FIG. 3 includes a composition analyzer 310, a query analyzer 320, a service selection interface 330, a weight manager 340, and a service predictor 350. The weight manager 340 includes a local analyzer 342 and a global analyzer 344. The composition analyzer 310, query analyzer 320, service selection interface 330, weight manager 340, and/or service predictor are in communication via a communication bus 360. The service predictor 350 uses information from the example composition analyzer 310, query data from the query analyzer 320, and/or weight data from the weight manager 340 to determine candidate services (N_{DST}) to be included in an application composition.

The example service predictor 350 of FIG. 3 uses a learning model (e.g., gradient descent) to determine candidate services (N_{DST}) that may be used in an application composition. The service predictor 350 may use the following scoring calculation:

score(C,G,q,N_{SRC},N_{DST})=\hat{w}φ(C,G,q,N_{SRC},N_{DST}) (1)

where parameter C represents the services catalog in the service catalog database 150, parameter G represents the current application composition, parameter q represents query information, parameter N_{SRC} represents a source application of the application composition, and parameter N_{DST} represents a candidate application service to be associated with the source application N_{SRC}. The vector ŵ is a weight vector that provides a numerical importance to each of the parameters C, G, q, N_{SRC}, N_{DST} of the feature function φ. For example, features that provide strong information for an accurate prediction (e.g., the presence of that parameter is frequently identified in other predictions) are assigned large weight values (positive or negative) and noisy, weak, or irrelevant features receive near-zero weight values. The service predictor 350 uses the feature function φ to encode and/or quantify information from the parameters C, G, q, N_{SRC}, N_{DST} for calculation with the weight vector ŵ. The example feature function φ may be implemented using any appropriate technique to generate a sparse feature vector and/or a vector of numbers based on the information from the parameters C, G, q, N_{SRC}, N_{DST}. For example, a feature function φ may be used that indicates how closely a query q matches an identifier or name of a particular candidate service (N_{DST}). Accordingly, Equation 1 determines a score indicating a likelihood that a candidate application service (N_{DST}) is to be selected for inclusion in an application composition and thus be associated with (e.g., connected to) the source application service (N_{SRC}). In some examples, other learning models and/or equations may be additionally or alternatively used to determine and/or predict a relevance of candidate services for inclusion in a corresponding application composition.

In the illustrated example of FIG. 3, the composition analyzer 310 provides the application composition parameter (G) representative of a current composition being built in the service engine 110 and/or the user interface 130. The composition analyzer 310 also provides the source application service (N_{SRC}) representative of an application to be associated with the candidate service (N_{DST}), which may be added to the application composition. The service predictor 350 determines relevant candidate services having the greatest likelihood of being included in the application composition based on prediction score calculations (e.g., using Equation 1) for corresponding candidate services (N_{DST}). The example prediction score calculations calculated by the service predictor 350 predict a degree of likelihood of candidate service(s) to be included in an application composition. As used herein, a prediction score indicates a degree of likelihood that a corresponding candidate service is to be selected for inclusion in an application composition. Accordingly, as used herein, the degree of likelihood may be based on at least one of relevance, user preference, compatibility, or other suitable factors.

In some examples, the service predictor 350 determines candidate services based on the source application service (N_{SRC}). For example, certain candidate services (N_{DST}) are not compatible with a particular source application service (N_{SRC}) based on parameters, type, data type, format, protocol, etc. of the source application service (N_{SRC}). In such examples, the service predictor 350 may crosscheck the source application service (N_{SRC}) with a compatibility database maintained by the service catalog database 150, session history database 140, or other database that may be included in the application services platform 100 of FIG. 1. The example compatibility database indicates compatibility between pairs of application services (e.g., between a source application service (N_{SRC}) and a particular candidate application service (N_{DST}). In such examples, the service predictor 350 may calculate a prediction score for compatible candidate services (N_{DST}) based on the source application service (N_{SRC}) and disregard any non-compatible candidate services (N_{DST}). Accordingly, in such examples, the service predictor 350 may perform substantially fewer score prediction calculations than calculating all score calculations for all possible candidate services regardless of such compatibility. It is noted that in such examples where the service predictor 350 calculates a prediction score for a candidate service (N_{DST1}) that is not compatible with a particular source application service (N_{SRC}), the resulting prediction score is likely to indicate less likelihood to be included in an application composition than a compatible candidate service (N_{DST2}) because the application service catalog is likely not to include any such application services including the source application service N_{SRC} being associated with non-compatible candidate service (N_{DST1}). Therefore, in such an example, a corresponding weight for the non-compatible candidate service (N_{DST1}) might be low relative to a weight corresponding to the compatible candidate service (N_{DST2}), resulting in prediction scores for the candidate services N_{DST1}, N_{DST2} indicating that the compatible candidate service (N_{DST2}) is more likely to be included in the application composition than the non-compatible candidate service (N_{DST1}).

The example composition analyzer 310 of FIG. 3 monitors an application composition (e.g., the application composition 230 of FIG. 2) being composed by the service engine 110 and/or in the user interface 130 of FIG. 1. The composition analyzer 310 analyzes the application composition and determines that a candidate service is to be selected for inclusion in the application composition. For example, the composition analyzer 310 may determine that a user is requesting to add a new service application (e.g., a service application represented by additional application service icons 220E and 220F) to the application composition. The composition analyzer 310 may determine that a new candidate service is to be selected based on a user's interactions with the application composition in the user interface 130. When the composition analyzer 310 determines that a new application service is to be included in the monitored application composition, the composition analyzer 310 may instruct the service predictor 350 to determine candidate services for inclusion in the application composition. In some examples, the composition analyzer 310 may automatically determine that a new candidate service is to be selected based on a particular application service and/or configuration of the application composition.

The composition analyzer 310 of FIG. 3 provides application composition information (G). The application composition information (G) may be representative of the configuration of the application composition and/or application service(s) included in the application composition, etc. In some examples, the composition analyzer 310 indicates the source application service (N_{SRC}) to which the new service application is to be associated based on the position of the source application in the application composition relative to the new application service. For example, the position of the source application (N_{SRC}) in the application composition is such that the source application is to be executed before the candidate service (N_{DST}) in a flow of execution when the application composition is finalized, compiled, and executed.

The example query analyzer 320 of FIG. 3 retrieves and/or analyzes query data from the user interface 130 of FIG. 1 (e.g., via the search box 240 of FIG. 2). The query analyzer 320 parses the query data and/or provides the query data to the service predictor 350 for candidate service analysis and/or to the weight manager 340 for weight analysis.

The service predictor 350 of the illustrated example of FIG. 3 calculates the prediction scores for each of the determined candidate services N_{DST} based on the received/retrieved parameters C, G, q, N_{SRC} and corresponding weights of the parameters C, G, q, NN_{SRC}, and N_{DST}. Accordingly, the service predictor 350 retrieves a weight vector ŵ corresponding to each candidate service (N_{DST}) from the weight manager 340 as each candidate service (N_{DST}) has a different weight w_{dst} based on the parameters C, G, q, and N_{SRC} Furthermore, each weight w_{c}, w_{g}, w_{src} corresponding to the parameters C, G, q, N_{SRC} may vary based on the candidate service (N_{DST}). Furthermore, the service predictor 350 calculates a feature vector from the feature function φ. Using the feature vector and the weight vector ŵ, the service predictor 350 calculates a prediction score for each of the candidate services (N_{DST}). The service predictor 350, then compares the prediction scores for each of the candidate services (N_{DST}), and ranks the candidate services (N_{DST}) based on the corresponding prediction scores (e.g., by comparing the values of the prediction scores). The service predictor 350 provides the candidate services (N_{DST}) in rank order to the service selection interface 330 for presentation to a user via the user interface 130. In some examples, the service predictor 350 provides compatible candidate services (N_{DST}) to the service selection interface 330 and disregards non-compatible candidate services (N_{DST}) or candidate services (N_{DST}) having a corresponding prediction score below a threshold value. In some examples, the service predictor 350 provides a threshold number (e.g., five candidate services (N_{DST})) of candidate services (N_{DST}) to the service selection interface 330 for presentation.

The example service selection interface 330 of FIG. 3 presents the candidate services (N_{DST}) received from the service predictor 350 via the user interface 130. For example, the service selection interface 330 may be implemented via a prompt interface, a dialog box interface, a pop-up interface, etc. The service selection interface 330 monitors for user input or a user response from the user interface 130 in response to presenting the candidate services (N_{DST}) and provides feedback to the weight manager 340 based on the user input or user response. For example, the service selection interface 330 may determine whether one of the presented candidate services (N_{DST}) was selected, and if so, which of the presented candidate services (N_{DST}) was selected. As used herein, an accepted prediction occurs when a user selects the candidate service (N_{DST}) that received a most likely to be included prediction score relative to the other candidate service scores, and a rejected prediction occurs when the user selects a candidate service (N_{DST}) that did not receive a most likely to be included prediction score relative to the other candidate service score. In some examples, when the service selection interface 330 identifies a rejected prediction, the service selection interface may provide the selected candidate service (N_{DST}) to the weight manager 340 for feedback. Based on the selection (or lack thereof) made by the user, the weight manager 340 may adjust the weights w_{c}, w_{g}, w_{q}, w_{src}, w_{dst} for each of the parameters C, G, q, N_{SRC} and candidate services (N_{DST}).

The example weight manager 340 of FIG. 3 manages weights w_{c}, w_{g}, w_{q}, w_{src}, w_{dst} associated with the parameters C, G, q, N_{SRC}, N_{DST}. In some examples, the weight manager 340 manages weights associated with other parameters or a group of the parameters C, G, q, N_{SRC}, N_{DST}. The weight manager 340 includes a local analyzer 342 and a global analyzer 344. The example local analyzer 342 manages a local weight w_{local} for each of the weights w_{c}, w_{g}, w_{q}, w_{src}, w_{dst} based on information in the session history database 140 and/or feedback from the service selection interface 330. Accordingly, the local analyzer 342 may be used to manage local weights for corresponding users of the application service platform 100 of FIG. 1. The example global analyzer 344 manages a global weight w_{global} for each of the weights w_{c}, w_{g}, w_{g}, w_{src}, w_{dst} based on information in the services catalog database 150. Accordingly, the global analyzer 344 may be used to manage weights for users of the application services platform 100 as well as users of other application services platforms in communication with the application services platform 100 of FIG. 1. The weight manager 340 may adjust whether the weights w_{c}, w_{g}, w_{g}, w_{src}, w_{dst} are to rely more on local feedback or are to rely more on global service usage using the following equation:

w=(1−α)w_{global}+αw_{local} (2)

where α is a user preference factor having a value between 0 and 1 and weight w maybe at least one of the weights w_{c}, w_{g}, w_{q}, w_{src}, w_{dst}. In Equation 2, the greater the user preference factor α is, the greater the impact of the local weight w_{local} on the weight w. In some examples, the weight manager 340 monitors the feedback received from the service selection interface to determine whether to adjust the user preference factor α. For example, the weight manager 340 may increase the user preference factor α when rejected predictions are frequency received (i.e., the service predictor 350 did not accurately predict which application service was to be included based on the parameters), thus giving greater priority to the local weight w_{local} rather than the global weight w_{global} when calculating the weights w_{c}, w_{g}, w_{q}, w_{src}, w_{dst}. Other suitable techniques may be used in addition to or as an alternative to the example Equation 2 for adjusting whether weights relative to the local weight w_{local} or the global weight w_{global}.

The local analyzer 342 of the illustrated example monitors the feedback from the service selection interface 330 and information in the session history database 140 of FIG. 1. The local analyzer 342 manages the local weights w_{local} for each of the weights w_{c}, w_{g}, w_{q}, w_{src}, w_{dst} based on accepted predictions and rejected predictions identified by the service selection interface 330. For example, the local analyzer 342 may rank a first candidate service (N_{DST1}) higher than a second candidate service (N_{DST2} in the session history database 140 when the first candidate service (N_{DST1}) received a higher prediction score than the second candidate service (N_{DST2}) and an accepted prediction is received. However, the first candidate service (N_{DST1}) may be ranked lower than the second candidate service (N_{DST2}) in the session history database 140 when a rejected prediction is received, despite the first candidate service (N_{DST1}) receiving a more likely to be included prediction score than the second prediction score (N_{DST2}). Accordingly, the local weights w_{local} for each of the weights w_{c}, w_{g}, w_{q}, w_{src}, w_{dst} are determined based on user feedback and corresponding parameters C, G, q, N_{SRC}, N_{DST}. Accordingly, the weight manager 340 may implement a standard learning algorithm (e.g., gradient descent) for adjusting the weights w_{c}, w_{g}, w_{q}, w_{src}, w_{dst} after each iteration of providing the candidate services (N_{DST}) and/or receiving a user response.

The global analyzer 344 of the illustrated example of FIG. 3 monitors the service catalog of FIG. 1 to determine global weights w_{global} for each of the weights w_{c}, w_{g}, w_{q}, w_{src}, w_{dst}. As previously mentioned, the application services in the service catalog database 150 may be comprised of other services in the services catalog database 150. Accordingly, each of the application services in the service catalog database 150 may be analyzed to determine global feedback from the service catalog. For example, assuming application services S_{A}, S_{B}, S_{C}, multiple catalog services includes S_{A} followed by S_{B} and few catalog service include S_{A} followed by S_{C}. Accordingly, in such an example, given S_{A} as a source application service (N_{SRC}), the global analyzer 344 may likely determine that a weight corresponding to destination service S_{B} might be greater than a weight corresponding to destination S_{C}. As such, the global analyzer 344 may adjust global weights w_{global} for each of the weights w_{c}, w_{g}, w_{q}, w_{src}, w_{dst} in response to newly added application service. In some examples, the global analyzer 344 may periodically (e.g., daily, weekly, monthly, eta) analyze the service catalog 150 to update and/or adjust the global weights w_{global}.

As described herein, the service assistant 112 of FIG. 3 provides a user with candidate services for inclusion in an application composition. Using feedback from the user, the service assistant 112 of FIG. 3 learns (e.g., using a learning model such as gradient descent) which candidate services are more likely to be included in a given application composition and/or associated with a given source application service of the application composition.

While an example manner of implementing the service assistant 112 of FIG. 1 is illustrated in FIG. 3, at least one of the elements, processes and/or devices illustrated in FIG. 3 may be combined, divided, re-arranged, omitted, eliminated and/or implemented in any other way. Further, the composition analyzer 310, the query analyzer 320, the service selection interface 330, the weight manager 340, including the local analyzer 342 and the global analyzer 344, the service predictor 350, and/or, more generally, the service assistant 112 of FIG. 3 may be implemented by hardware, software, firmware and/or any combination of hardware, software and/or firmware. Thus, for example, any of the composition analyzer 310, the query analyzer 320, the service selection interface 330, the weight manager 340, including the local analyzer 342 and the global analyzer 344, the service predictor 350 and/or, more generally, the service assistant 112 could be implemented by at least one of analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the composition analyzer 310, the query analyzer 320, the service selection interface 330, the weight manager 340, including the local analyzer 342 and global analyzer 344, and/or the example service predictor 350 is/are hereby expressly defined to include a tangible computer readable storage device or storage disk such as a memory, a digital versatile disk (DVD), a compact disk (CD), a Blu-ray disk, etc. storing the software and/or firmware. Further still, the example service assistant 112 of FIG. 3 may include at least one of elements, processes and/or devices in addition to, or instead of, those illustrated in FIG. 3, and/or may include more than one of any or all of the illustrated elements, processes and devices.

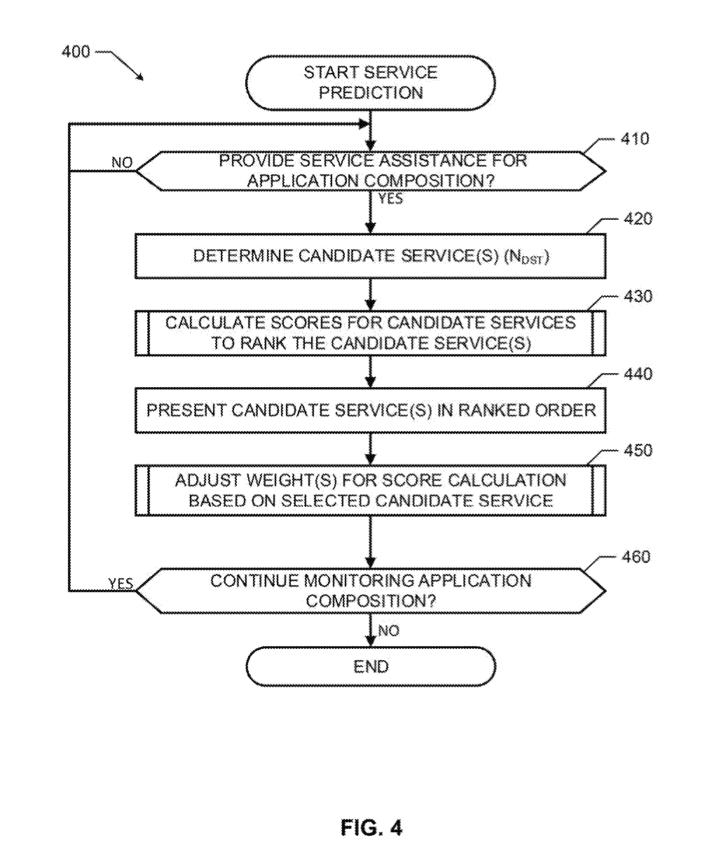

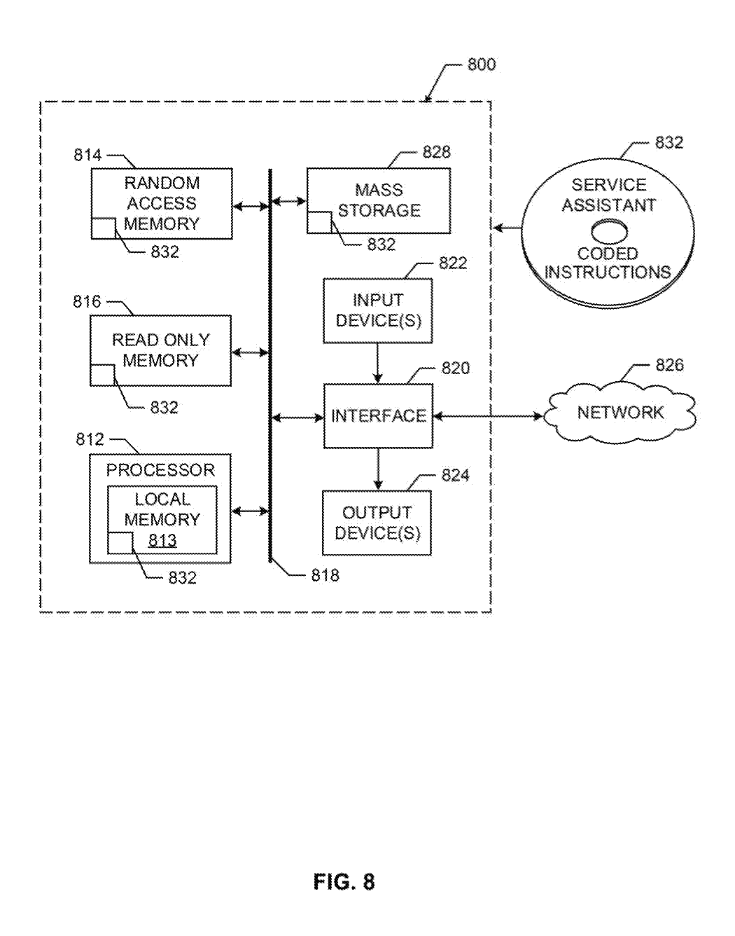

Flowcharts representative of example machine readable instructions for implementing the service assistant 112 of FIG. 3 are shown in FIGS. 4, 5, 6, and/or 7. In this example, the machine readable instructions comprise programs for execution by a processor, such as the processor 812 shown in the example processor platform 800 discussed below in connection with FIG. 8. The program may be embodied in software (e.g., the coded instructions 832 of FIG. 8) stored on a tangible computer readable storage medium such as a CD-ROM, a floppy disk, a hard drive, a digital versatile disk (DVD), a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowcharts illustrated in FIGS. 4, 5, 6, and/or 7, many other methods of implementing the example service assistant 112 may alternatively be used. For example, the order of execution of the blocks may be changed, and/or some of the blocks described may be changed, eliminated, or combined.

The program 400 of FIG. 4 begins with an initiation of the service assistant 112 of FIGS. 1 and/or 3 (e.g., upon startup of the service engine 110, upon receiving instructions from the user interface 130). At block 410, the service assistant 112 determines whether to provide service assistance. For example, at block 410, the composition analyzer 310 may determine that a user is composing an application service based on selection of a source application service of an application composition. In some examples, the service assistant 112 may a receive request for assistance via the user interface 130 of FIG. 1 and/or graphical user interface (e.g., the graphical user interface 200 of FIG. 2) implemented via the user interface 130. If the service assistant 112 determines that service assistance is not to be provided, the service assistant 112 continues to monitor whether service assistance is to be provided (control returns to block 410). If the service assistant 112 determines that service assistance is to be provided, control advances to block 420.

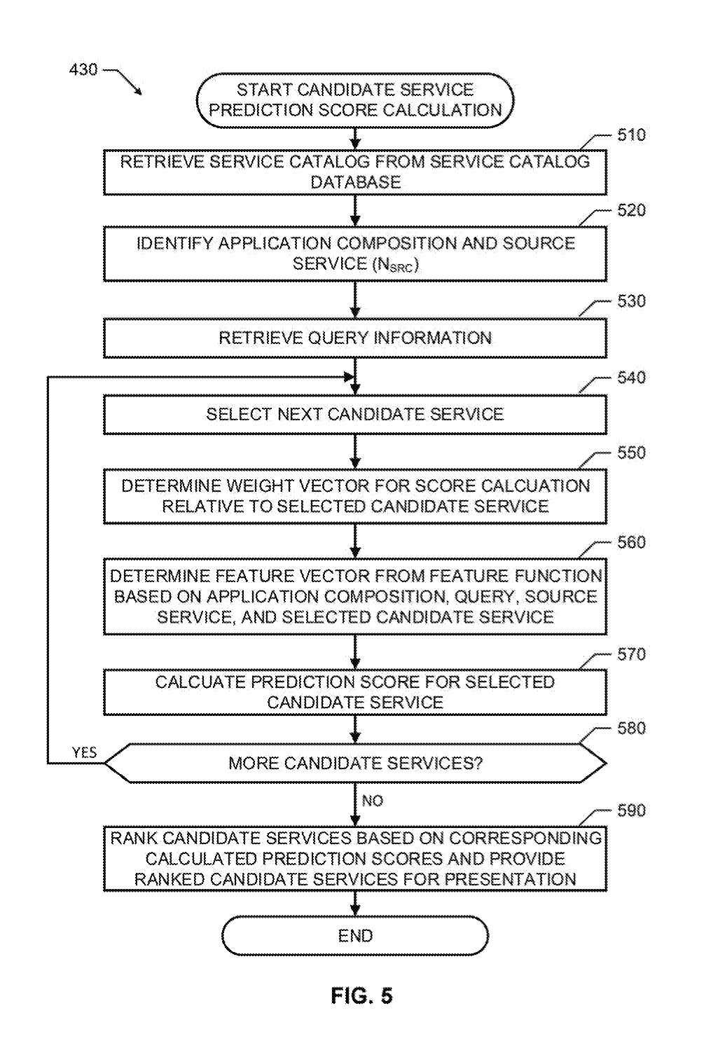

At block 420, the service predictor 350 of FIG. 3 determines candidate services for the application composition. In some examples, the service predictor 350 identifies compatible candidate services based on the source application service of the application composition. In some examples, the candidate services may be any service in a service catalog (e.g., the service catalog database 150). At block 430, the service predictor 350 calculates prediction scores for the candidate services using a prediction score calculation (e.g., Equation 1), as described in further detail in connection with FIG. 5.

In FIG. 4, the service selection interface 330 of FIG. 3 presents the candidate services in rank order via a user interface (e.g., the user interface 130 of FIG. 1) (block 440). For example, the service selection interface 330 presents the candidate services from most relevant to least relevant based on the prediction score calculations. At block 450, the weight manager 340 adjusts weight(s) of the prediction score calculation based on the selected candidate service. In some examples, the service selection interface 330 indicates a selected service based on an accepted prediction corresponding to a selection of the candidate service with a highest prediction score relative to other presented candidate services or a rejected prediction corresponding to a selection of a candidate service that was not the candidate service with the highest prediction score relative to the other presented candidate services.

At block 460, the service assistant 112 determines whether to continue monitoring the application composition. If the service assistant 112 is to continue monitoring the application composition (the user has not requested to finalize and/or compile the application composition into an application service), control returns to block 410. If the service assistant 112 determines that it is not to continue monitoring the application composition (e.g., a user indicates the application composition is finalized and/or is to be compiled by the service engine 110, the user terminates the application composition, etc.), the program ends.

The program 430 of FIG. 5 begins in response to the service predictor 350 identifying candidate services that may be included in an application composition. The program 430 facilitates calculation of prediction scores for the identified candidate services and may be executed to implement block 430 of FIG. 4. At block 510 of FIG. 5, the service predictor 350 retrieves service catalog information (C) from the service catalog database 150. At block 520, the service predictor 350 retrieves application composition information (G) and source application service information (N_{SRC}) from the composition analyzer 310. At block 530, the service predictor 350 retrieves query information (q) from the query analyzer 320.

At block 540 of the illustrated example of FIG. 5, the service predictor selects a candidate service (N_{DST}) for prediction score calculation. At block 550, the service predictor 350 determines the weight vector for the prediction score calculation for the candidate service by retrieving weight values w_{c}, w_{g}, w_{q}, w_{src}, w_{dst} from the weight manager 340 for the corresponding candidate service (N_{DST}) and corresponding parameters C, G, q, and N_{SRC}. At block 560, the service predictor 350 determines a feature vector (e.g., a sparse feature vector, basic number vector, etc.) from the feature function φ using suitable techniques based on the application composition, query information, source application service, and selected candidate service. At block 570, the service predictor 350 calculates the prediction score for the selected candidate service (N_{DST}).

At block 580, the service predictor 350 determines whether there are more candidate services for which the service predictor 350 is to perform a prediction score calculation. If more candidate services remain, control returns to block 540. If no more candidate services remain, the service predictor 350 ranks the candidate services based on the corresponding calculated prediction scores and provides the ranked candidate services to the service selection interface 330 for presentation to a user (block 590). After block 590, the program 430 ends.

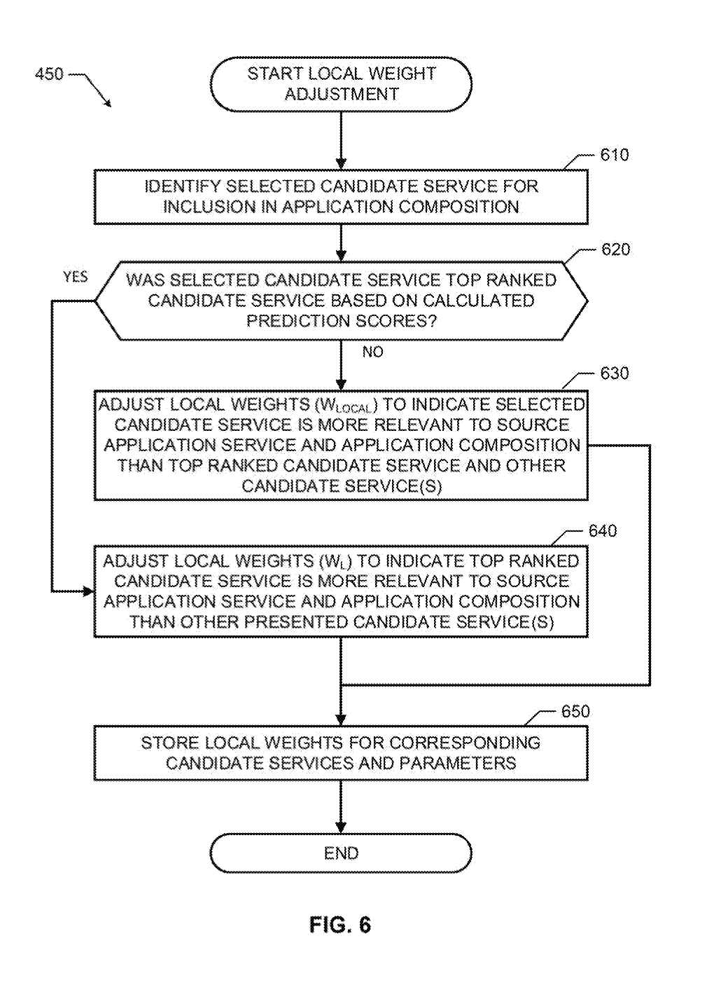

The program 450 of FIG. 6 begins in response to receiving user feedback via the service selection interface 330 of FIG. 3. The program 450 facilitates local weight adjustment based on user feedback (e.g., a selection of a presented candidate service) received by the weight manager 340 of FIG. 3 via the service selection interface 330. At block 610, the weight manager 340 identifies the selected candidate service for inclusion in the application composition. In some examples, at block 610, the weight manager 340 determines whether an accepted prediction or a rejected prediction was made based on feedback from the service selection interface 330.

At block 620 of FIG. 6, the weight manager 340 determines whether the selected candidate service was the top ranked candidate service based on the calculated prediction scores for the presented candidate services. If, at block 620, the weight manager 340 determines the selected candidate service was not the top ranked candidate service relative to the other candidate services (e.g., the predicted most relevant), the weight manager 340 adjusts the local weights w_{local} to indicate the selected candidate service is more relevant to the source application service (N_{SRC}) and the application composition (G) than the top ranked candidate service and other candidate service(s) that were presented (block 630). If, at block 620, the weight manager 340 determines the selected candidate service was the top ranked candidate service relative to the other presented candidate services, the weight manager 340 adjusts the local weights w_{local} to indicate the top ranked candidate service is more relevant to the source application service (N_{SRC}) and the application composition (G) than the other presented candidate service(s) that were presented. Following blocks 630 and 640, at block 650, the weight manager 340 stores the update local weights for the corresponding candidate services N_{DST} and parameters C, G, q, N_{SRC}.

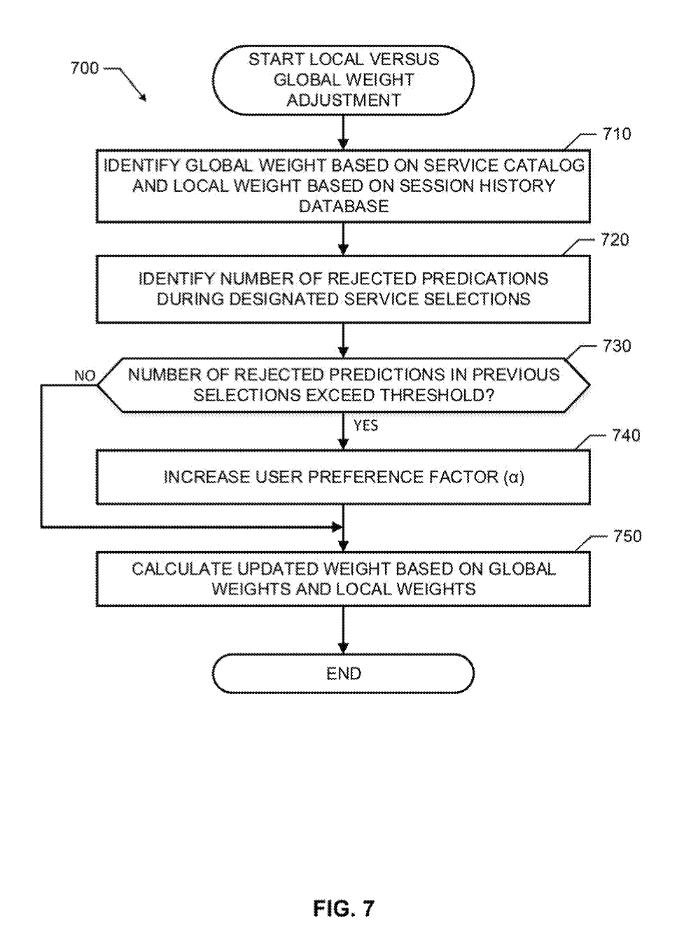

The program 700 of FIG. 7 begins with an initiation of the weight manager 340 of FIG. 3 to determine whether to increase priority for local weights w_{local} over global weights w_{global}. In some examples, the program 700 may be executed in response to receiving a rejected prediction feedback from the service selection interface 330 of FIG. 3. In some examples, the program 700 executes in the background and/or simultaneously to the programs of FIGS. 4, 5, and/or 6. In some examples, the program 700 may be executed on a periodic basis (e.g., daily, weekly, monthly, etc.). At block 710 of FIG. 7, the weight manager 340 determines the global weight w_{global} based on the service catalog in the service catalog database 150 and the local weight w_{local} based on the session history database 140. At block 720, the weight manager 340 identifies the number of rejected predictions that occurred during designated service selections (e.g., over the last 10, 20, 100, service selections). In some examples, in block 720, the weight manager 340 may monitor the number of rejected predictions during a designated time period (e.g., a day, a week, a month, etc.).

At block 730 of FIG. 7, the weight manager 340 of FIG. 3 determines whether the number of rejected predictions that occurred during the designated selections satisfies a threshold (e.g., a threshold percentage of the selections were rejected predictions). If the number of rejected predictions satisfies the threshold, the weight manager 340 may increase a user preference factor α (block 740). If, at block 730, the number of rejected predictions does not satisfy the threshold control advances to 750. At block 750, the weight manager 340 calculates an adjusted weight based on the global weights w_{global} and local weights w_{local} (e.g., using Equation 2). After block 750, the program 700 ends.

As mentioned above, the example processes of FIGS. 4, 5, 6, and/or 7 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 4, 5, 6, and/or may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 8 is a block diagram of an example processor platform 800 capable of executing the instructions of FIGS. 4, 5, 6, and/or 7 to implement the service assistant 112 of FIG. 3 and/or the application services platform 100 of FIG. 1. The processor platform 800 can be, for example, a server, a personal computer, a mobile device (e.g., a cell phone, a smart phone, a tablet such as an iPad™), a personal digital assistant (PDA), an Internet appliance, a digital video recorder, a gaming console, or any other type of computing device.

The processor platform 800 of the illustrated example of FIG. 8 includes a processor 812. The processor 812 of the illustrated example is hardware. For example, the processor 812 can be implemented by at least one of integrated circuits, logic circuits, microprocessors or controllers from any desired family or manufacturer.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, at least one of input devices 822 are connected to the interface circuit 820. The input device(s) 822 permit(s) a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system. The example input devices 822 may be used to implement the user interface 130 of FIG. 1 and/or service selection interface 330 of FIG. 1.

At least one of the output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 820 of the illustrated example, thus, typically includes a graphics driver card, a graphics driver chip or a graphics driver processor.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes at least one mass storage device(s) 828 for storing software and/or data. Examples of such mass storage devices 828 include floppy disk drives, hard drive disks, compact disk drives, Blu-ray disk drives, RAID systems, and digital versatile disk (DVD) drives.

The service assistant coded instructions 832 of FIGS. 4, 5, 6, and/or 7 may be stored in the mass storage device 828, in the local memory 813 in the volatile memory 814, in the non-volatile memory 816, and/or on a removable tangible computer readable storage medium such as a CD or DVD. The example coded instructions 832 may be executed to implement the service assistant 112 of FIGS. 1 and/or 3.

From the foregoing, it will be appreciated that the above disclosed methods, apparatus and articles of manufacture provide adaptive user assistance in an application services platform. Example methods, apparatus, and articles of manufacture monitor application compositions and provide assistance by providing suggested application service(s) to be included in the application composition based on at least one of available services in a service catalog, the current state of the application composition, a source application service in the application composition to which the suggested application service(s) is to be associated, the feedback determined from previous suggestions of the candidate services, and/or the frequency of use of the candidate service applications in the service catalog. Accordingly, a most relevant process is predicted and can be provided to a user to efficiently enable composition of a new application service.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising, via at least one processor:
determining a plurality of candidate services for a cloud application;
determining an indication that a first candidate service from the plurality of candidate services is more relevant to the cloud application than a second candidate service based on a first prediction score corresponding to the first candidate service and a second prediction score corresponding to the second candidate service;
presenting the first candidate service and the second candidate service to a user based on the first prediction score and the second prediction score; and
adjusting a first weight corresponding to the first candidate service and a second weight corresponding to the second candidate service based on whether the first candidate service or the second candidate service is selected for inclusion in the cloud application.

2. The method of claim 1, wherein the first weight is increased relative to the second weight when the first candidate service is selected.

3. The method of claim 1, wherein the first weight and the second weight are adjusted based on a machine learning algorithm.

4. The method of claim 1, wherein the first prediction score and the second prediction score are calculated based on a source service of the cloud application, the source service to precede the selected first candidate service or the selected second candidate service in the cloud application.

5. The method of claim 1, further comprising retrieving a query from a user, the query to be used to calculate the first prediction score for the first candidate service and the second prediction score for the second candidate service.

6. The method of claim 1, wherein at least one of the first weight and the second weight comprise a global weight, the global weight generated from the plurality of candidate services.

7. The method of claim 1, wherein the first candidate service and the second candidate service are presented to the user based on a ranked order of the first prediction score and the second prediction score.

8. An apparatus comprising:
a composition analyzer to analyze an application composition and determine that a candidate service is to be selected for inclusion in the application composition;
a service predictor to predict a most relevant candidate service to be included in the application composition based on:
a calculation of prediction scores for each of a plurality of candidate services,
a comparison of the prediction scores, and
a prediction of a most relevant candidate service based on the compared prediction scores;
a service selection interface to present the identified most relevant candidate service and the plurality of candidate services; and
a weight manager to adjust weights in the calculation of prediction scores based on a selected service from the most relevant candidate service and the plurality of candidate services.

9. The apparatus of claim 8, wherein the weight manager is to adjust weights of a weight vector used to calculate the prediction scores for each of the plurality of candidate services.

10. The apparatus of claim 9, wherein the weights comprise global weights, and the weight manager calculates global weights of the weight vector based on services in a service catalog.

11. The apparatus of claim 10, wherein the weight manager is to adjust a preference of the local weights over the global weights based on the selected service being different from the predicted most relevant candidate service.

12. Anon-transitory computer readable storage medium comprising instructions that, when executed, cause a machine to at least:
identify a source service of an application composition;
determine that a destination service for the application composition is to be associated with the source service;
predict whether the destination service is to comprise at least one of a first candidate service or a second candidate service; and
present the first candidate service and the second candidate service via a display to a user for selection as the destination service of the application composition.

13. The non-transitory computer readable storage medium of claim 12, wherein the instructions further cause the machine to adjust a first weight corresponding to the first candidate service and a second weight corresponding to the second candidate service based on a selection of the first candidate service or the second candidate service to be included in the application composition.

14. The non-transitory computer readable storage medium of claim 12, wherein the instructions cause the machine to predict the destination service by calculating a first prediction score for the first candidate service and a second prediction score for the second candidate service, wherein the first prediction score and the second prediction score indicate a predicted relevance of the first candidate service and the second candidate service to the application composition, respectively.

15. The non-transitory computer readable storage medium of claim 12, wherein the instructions further cause the machine to:
identify a service catalog comprising the first candidate service and the second candidate service; and
determine that the first candidate service and the second candidate service are eligible services to be associated with the source service based on the source service and the application composition.

16. The non-transitory computer readable storage medium of claim 12, wherein the instructions cause the machine to present the first candidate service and the second candidate service in a rank order based on a most relevant service to be included in the application composition.
